(19) United States
(12) Patent Application Publication
(10) Pub. No.: US 2009/0227749 A1
(43) Pub. Date: Sep. 10, 2009

(54) PROCESS FOR PRODUCING PERFLUOROCARBON POLYMER

(75) Inventors: Jyunichi TAYANAGI, Chiyoda-ku (JP); Susumu SAITO, Chiyoda-ku (JP); Adam Luke SAFIR, Sunnyvale, CA (US)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 12/042,810

(22) Filed: Mar. 5, 2008

(51) Int. Cl. C08F 2/00

(52) U.S. Cl. 526/214

(57) ABSTRACT

To provide a process for producing a perfluorocarbon polymer, whereby a perfluorocarbon polymer having a high content of —SO₂F groups and a high molecular weight can be efficiently obtained. The process comprises polymerizing a monomer mixture comprising the liquid monomer (A) of the following formula (1) and tetrafluoroethylene at a polymerization temperature of from 25 to 45° C. by sequentially or continuously adding an initiator of the following formula (2):

CF₂═CF(OCF₂CFX¹)ₖ—O₁—(CF₂)ₘ—(CF₂CFX²)ₙ—SO₂F (1)

wherein each of X¹ and X² which may be the same or different, is a fluorine atom or a trifluoromethyl group, k is an integer of from 0 to 3, l is 0 or 1, m is an integer of from 0 to 12, and n is an integer of from 0 to 3,

[CF₃CF₂CF₂O(CF(CF₃)CF₂O)ₚCF(CF₃)COO]₂ (2)

wherein p is an integer of from 0 to 8.

### BACKGROUND OF THE INVENTION

1. Field of the Invention

The present invention relates to a process for producing a perfluorocarbon polymer which is suitable for use as a raw material for an electrolyte material.

2. Discussion of Background

A polymer having sulfonic acid groups (hereinafter referred to as a sulfonic acid polymer) is excellent in heat resistance, chemical resistance, durability, stability for a long time, etc., and thus commonly used as an electrolyte material for diaphragms for fuel cells or cation exchange membranes for electrolysis for sodium chloride.

In such a sulfonic acid polymer, at least some of terminal groups on the polymer main chain are unstable terminal groups such as —COOH groups or —COF groups. It is known that accordingly, if it is exposed to an electrode reaction for a long period, it undergoes deterioration as the main chain undergoes decomposition by a chain reaction from such unstable terminal groups.

As a method for producing a sulfonic acid polymer whereby unstable terminal groups will be scarcely formed, a method is proposed wherein a radical polymerization initiator made of a fluorinated compound is added at the beginning of the polymerization to polymerize a perfluorocarbon monomer, and the obtained polymer having —SO₂F groups are hydrolyzed, followed by treatment for conversion to an acid form (Patent Documents 1 and 2).

Patent Document 1: WO2004/52954

Patent Document 2: JP-A-2006-173098

However, the sulfonic acid polymer obtainable by the method of Patent Document 1 has had a problem that the ion exchange capacity is not sufficient, and the electric resistance tends to be high. Whereas by the method of Patent Document 2, it is possible to obtain a sulfonic acid polymer having a high ion exchange capacity, but it has been difficult to make the molecular weight high, and the mechanical strength has tended to be inadequate.

Thus, it has heretofore been difficult to obtain a sulfonic acid polymer which has both a high ion exchange capacity and a high molecular weight.

### SUMMARY OF THE INVENTION

The present invention has been made under the above-described circumstances, and it is an object of the present invention to provide a process for producing a perfluorocarbon polymer whereby it is possible to efficiently obtain a perfluorocarbon polymer having a high content of —SO₂F groups and a high molecular weight, for the purpose of obtaining a sulfonic acid polymer having both a high ion exchange capacity and a high molecular weight.

To accomplish the above objective, the present invention provides the following.

(1) A process for producing a perfluorocarbon polymer comprising from 20 to 40 mol % of structural units obtainable from a liquid monomer (A) of the following formula (1) and structural units obtainable from tetrafluoroethylene, and having a molecular weight of at least 250,000 and a mass per mol of —SO₂F groups being from 600 to 900 g/mol, by polymerizing a monomer mixture comprising the liquid monomer (A) and tetrafluoroethylene at a polymerization temperature of from 25 to 45° C. by sequentially or continuously adding an initiator of the following formula (2):

CF₂═CF(OCF₂CFX¹)ₖ—O₁—(CF₂)ₘ—(CF₂CFX²)ₙ—SO₂F (1)

wherein each of X¹ and X² which may be the same or different, is a fluorine atom or a trifluoromethyl group, k is an integer of from 0 to 3, l is 0 or 1, m is an integer of from 0 to 12, and n is an integer of from 0 to 3,

[CF₃CF₂CF₂O(CF(CF₃)CF₂O)ₚCF(CF₃)COO]₂ (2)

wherein p is an integer of from 0 to 8.

(2) The process for producing a perfluorocarbon polymer according to (1), wherein the monomer mixture further contains a liquid monomer of the following formula (3) and/or a liquid monomer of the following formula (4)

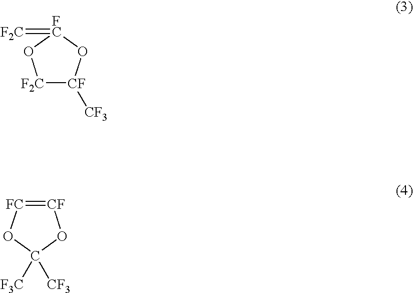

(3) The process for producing a perfluorocarbon polymer according to (1), wherein the concentration of the initiator (X) during the polymerization is maintained within a range of from 0.25 to 2 times the concentration of the initiator (X) at the beginning of the polymerization.

(4) The process for producing a perfluorocarbon polymer according to (1), wherein the concentration of the initiator (X) during the polymerization is maintained within a range of from 0.5 to 1.5 times the concentration of the initiator (X) at the beginning of the polymerization.

(5) The process for producing a perfluorocarbon polymer according to (1), wherein the molar ratio of the total amount of the initiator (X) to be added, to all liquid monomers, is adjusted to be from 1×10⁻⁵ to 3×10⁻³.

(6) The process for producing a perfluorocarbon polymer according to (1), wherein the molar ratio of the total amount of the initiator (X) to be added, to all liquid monomers, is adjusted to be from 5×10⁻⁵ to 1×10⁻³.

(7) The process for producing a perfluorocarbon polymer according to (1), wherein the polymerization is carried out at a polymerization temperature of from 30 to 45° C.

(8) The process for producing a perfluorocarbon polymer according to (1), wherein the molecular weight is at least 400,000.

According to the present invention, it is possible to efficiently produce a perfluorocarbon polymer having a high content of —SO₂F groups and a high molecular weight.

When a perfluorocarbon polymer obtainable by the present invention is used as a raw material, it is possible to obtain a sulfonic acid polymer which has a low electric resistance as the ion exchange capacity is high and which has a high molecular weight and is excellent in the mechanical strength.

Namely, according to the present invention, it is possible to produce a perfluorocarbon polymer suitable as a raw material for an electrolyte material for high quality diaphragms for fuel cells or ion exchange membranes for electrolysis for sodium chloride.

### DETAILED DESCRIPTION OF THE PREFERRED EMBODIMENTS

### Structural Units

The present invention provides a process for producing a perfluorocarbon polymer (hereinafter referred to as “the present polymer” comprising from 20 to 40 mol % of structural units obtainable from a liquid monomer (A) of the following formula (1) and structural units obtainable from tetrafluoroethylene (hereinafter referred to as TFE) and having a molecular weight of at least 250,000 and a mass per mol of —SO₂F groups being from 600 to 900 g/mol.

CF₂═CF(OCF₂CFX¹)ₖ—O₁—(CF₂)ₘ—(CF₂CFX²)ₙ—SO₂F (1)

wherein each of X¹ and X² which may be the same or different, is a fluorine atom or a trifluoromethyl group, k is an integer of from 0 to 3, l is 0 or 1, m is an integer of from 0 to 12, and n is an integer of from 0 to 3.

In the formula (1), k is preferably an integer of from 0 to 2, -l is preferably 0 or 1 (provided that when k is 0, l is 1), m is preferably an integer of from 0 to 4, and n is preferably 0. Particularly preferred is one wherein with respect to k, l, m and n, the above preferred values are combined. Specifically, the following may, for example, be mentioned:

CF₂═CFO(CF₂)₂SO₂F

CF₂═CFO(CF₂)₃SO₂F

CF₂═CFO(CF₂)₄SO₂F

CF₂═CFOCF₂CF(CF₃)O(CF₂)₂SO₂F

CF₂═CFOCF₂CF₂O(CF₂)₂SO₂F

The monomer mixture to obtain the present polymer comprises the liquid monomer (A) and TFE. Further, the monomer mixture to obtain the present polymer may contain, in addition to the liquid monomer (A) and TFE, other monomers copolymerizable therewith.

Namely, the present polymer may contain, in addition to structural units obtainable from the liquid monomer (A) and structural units obtainable from TFE, structural units obtainable from other monomers copolymerizable therewith.

It is preferred to contain as such copolymerizable other monomers, a liquid monomer of the following formula (3) (hereinafter referred to as MMD) and/or a liquid monomer of the following formula (4) (hereinafter referred to as PDD). When the present polymer contains structural units obtainable from such monomers, the softening point of an electrolyte material obtainable from the present polymer can be made high.

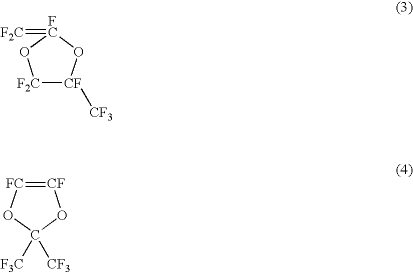

As copolymerizable monomers other than MMD and PDD, compounds of the formulae CF₂═CFOR^{f1}, CH₂═CHR^{f2} and CH₂═CHCH₂R^{f2} may also be used. Here, R^{f1} is a C₁₋₁₂ perfluoroalkyl group, which may have a branched structure or which may contain an etheric oxygen atom, and R^{f2} is a C₁₋₁₂ perfluoroalkyl group. Further, a gaseous monomer such as chlorotrifluoroethylene, vinylidene fluoride, hexafluoropropylene, trifluoroethylene, vinyl fluoride, ethylene or propylene may, also be used.

Among them, it is particularly preferred to employ a perfluoromonomer (which may contain an etheric oxygen atom), from the viewpoint of the chemical stability and durability.

Among the above monomers, the compound of the formula CF₂═CFOR^{f1} is preferably a perfluorovinylether compound of the formula CF₂═CF—(OCF₂CFZ)_{y}—O—R⁴, wherein y is an integer of from 0 to 3, Z is a fluorine atom or a trifluoromethyl group, and R^{f4} is a linear or branched C₁₋₁₂ perfluoroalkyl group (hereinafter R^{f4} is used as having the same meaning in this specification).

Among them, compounds of the following formulae (5) to (7) are preferably mentioned. In the following formulae (5) to (7), a is an integer of from 1 to 8, b is an integer of from 1 to 8, and c is 2 or 3.

CF₂═CFO(CF₂)ₐCF₃ (5)

CF₂═CFOCF₂CF(CF₃)O(CF₂)_{b}CF₃ (6)

CF₂═CF(OCF₂CF(CF₃))_{c}O(CF₂)₂CF₃ (7)

In the present invention, “a liquid monomer” means a monomer which is liquid at the polymerization temperature, and “a gaseous monomer” means a monomer which is gaseous at the polymerization temperature.

The proportion of structural units obtainable from a liquid monomer (A) in the present polymer is from 20 to 40 mol %, preferably from 20 to 35 mol %. Further, the proportion of structural units of (A) is adjusted so that the mass per mol of —SO₂F groups of the obtainable polymer will be from 600 to 900 g/mol.

The proportion of structural units obtainable from TFE in the present polymer is preferably from 10 to 80 mol %, more preferably from 20 to 78 mol %. The total proportion of the structural units obtainable from a liquid monomer (A) and the structural units obtainable from TFE in the present polymer is preferably from 30 to 100 mol %, more preferably from 50 to 100 mol %.

When the monomer mixture contains MMD and/or PDD, the proportion of structural units obtainable from such monomers in the present polymer is preferably from 1 to 70 mol %, more preferably from 5 to 50 mol %.

The proportions of the feeding amounts of the respective monomers used in the polymerization to obtain the present polymer may not necessarily be the same as proportions of the structural units of such monomers contained within the present copolymer. For example, the proportion of structural units obtainable from a liquid monomer (A) tends to be lower than the proportion of the liquid monomer (A) used in the monomer mixture. Accordingly, the proportion of the liquid monomer (A) in the monomer mixture is preferably adjusted to be higher than the desired proportion of the structural units.

Further, MMD and PDD are likely to be consumed during the reaction more rapidly than the liquid monomer (A), and their proportion in the monomer mixture tends to be low. Therefore, it is preferred to sequentially add them during the polymerization reaction to maintain their proportion in the monomer mixture within a constant range.

### Polymerization Temperature

In the present invention, the polymerization temperature is from 25 to 45° C., preferably from 30 to 45° C., more preferably from 35 to 45° C.

If the polymerization temperature is too low, a sufficient polymerization rate cannot be obtained, and it tends to be difficult to obtain a polymer having a high molecular weight. Further, there is a problem that as the polymerization proceeds, the viscosity will increase, whereby stirring tends to be difficult. On the other hand, if the polymerization temperature is too high, a chain transfer reaction due to vinyl ether decomposition is likely to occur, and also in such a case, it tends to be difficult to obtain a polymer having a sufficiently high molecular weight.

It is considered that when the polymerization temperature is within the range defined by the present invention, the polymerization accelerating effect will be higher than the chain transfer reaction-accelerating effect, whereby it becomes possible to make the molecular weight high.

The polymerization temperature is preferably maintained to be as constant as far as possible during the polymerization reaction, such that control of the product quality of the obtainable polymer will be easy.

### Initiator

In the present invention, the monomer mixture is polymerized by means of an initiator (X). The initiator (X) is represented by the following formula (2):

[CF₃CF₂CF₂O(CF(CF₃)CF₂O)ₚCF(CF₃)COO]₂ (2)

wherein p is an integer of from 0 to 8.

In the formula (2), p is preferably from 0 to 4, more preferably from 0 to 2.

The 10 hour half life temperature of the initiator (X) is, for example 16.4° C. when p is 1, and it is lower than 25° C., when p is any value of from 0 to 8. Therefore, a sufficient polymerization rate can be obtained within the polymerization temperature range as defined by the present invention.

Here, the 10 hour half life temperature means a temperature at which the amount of the initiator becomes one half upon expiration of 10 hours from the initiation of the polymerization. In a case where the decomposition reaction temperature of the initiator is substantially lower than the polymerization temperature, the radical-generation efficiency will be low, and it will be required to use a large amount of the initiator. If the decomposition reaction temperature of the initiator is substantially higher than the polymerization temperature, the polymerization time tends to be long, and the production efficiency will be low, such being industrially disadvantageous.

The relation between the polymerization temperature and the half life of the initiator is not particularly limited, but the half life of the initiator at the polymerization temperature is preferably at a level of from one minute to 5 hours, more preferably from 10 minutes to two hours, particularly preferably from 10 minutes to one hour. If the half life is too short, control of the addition of the initiator tends to be difficult.

Within the range of from 25 to 45° C., the polymerization temperature may be adjusted so that the half life will be in the proper range.

The initiator (X) is not added all at once at the beginning of the polymerization but is added sequentially or continuously, whereby a polymer having a large molecular weight can be obtained efficiently while the molecular weight is controlled without presenting a large change in the polymerization rate or the initiator concentration and without lowering the polymerization rate. The addition is preferably sequential, since the polymerization equipment can thereby be simplified, and the production control will be easy. However, in order to control the concentration of the initiator (X) to be constant as far as possible during the polymerization, it is preferred to add it continuously.

During the polymerization, it is preferred to maintain the concentration of the initiator (X) so that it will not change substantially.

The molecular weight of the polymer is inversely proportional to the square root of the concentration of the initiator. Accordingly, if the change in the concentration in the initiator (X) is too large, the distribution of the molecular weights of the obtainable polymer will be wide. Further, there will be a problem such that the concentration of the initiator (X) becomes temporarily too high, and it tends to be difficult to control the polymerization rate or to control the molecular weight of the obtainable polymer due to acceleration of the decomposition of the initiator by the heat generation at the polymerization site.

Specifically, the concentration of the initiator (X) is preferably maintained within a range of from 0.25 to 2 times, more preferably within a range of from 0.5 to 1.5 times, the concentration of the initiator (X) at the beginning of the polymerization.

The molar ratio of the total amount of the initiator (X) to be added to all liquid monomers is preferably from 5×10⁻⁶ to 5×10⁻³, or preferably from 1×10⁻⁵ to 3×10⁻³, particularly preferably from 5×10⁻⁵ to 1×10⁻³.

If the molar ratio is too small, no adequate polymerization rate can be obtained. On the other hand, if the molar ratio is too large, there will be a problem such that the polymerization rate becomes too high, and it tends to be difficult to obtain a polymer having a sufficient polymerization degree.

The concentration of the initiator in the system (in the polymerization reactor) can be calculated from the half life of the initiator at the polymerization temperature. When it is added sequentially, a specific method for the addition of the initiator may, for example, be a method wherein one half of the initially added initial amount is added every half life. In such a case, in the system, there will always be the initiator in an amount of from 0.5 to 1 time the initial concentration. Further, the initial concentration of the initiator can be determined from the total amount of the initiator desired to be finally added to the system and the polymerization time. Referring to a specific example, in a case where the polymerization time is 8 hours by using an initiator having a half life of one hour at the practical polymerization temperature, the initiator in an amount corresponding to ⅕ of the intended total amount of the initiator is initially added, and the initiator in an amount corresponding to 1/10 of the intended total amount of the initiator is added every one hour, whereby in the system, the initiator is always contained in an amount of from 0.5 to 1 time the initial concentration.

### Polymerization Method

As a polymerization method of the present invention, a known polymerization method such as suspension polymerization, solution polymerization, emulsion polymerization or bulk polymerization may be employed without restriction. However, solution polymerization or bulk polymerization is particularly preferred. In suspension polymerization and emulsion polymerization, water is employed as a polymerization medium, and the perfluorocarbon monomer is hardly soluble in the polymerization medium, whereby it is difficult to carry out the polymerization constantly.

As a polymerization medium in the case of solution polymerization, a fluorinated organic solvent having a small chain transfer constant is preferred. Particularly preferred is at least one member selected from the group consisting of a C₃₋₁₀ perfluorocarbon, a C₃₋₁₀ hydrofluorocarbon, a C₃₋₁₀ hydrochlorofluorocarbon and a C₃₋₁₀ chlorofluorocarbon. Such a halo-carbon may preferably be used in a linear, branched or cyclic structure, and it may contain an etheric oxygen atom in its molecule but is preferably a saturated compound.

The following may be mentioned as specific polymerization media.

As a perfluorocarbon, perfluorocyclobutane, perfluorohexane, perfluoro(dipropyl ether), perfluorcyclohexane, or perfluoro(2-butyltetrahydrofuran) may, for example, be mentioned.

The hydrofluorocarbon is preferably such that the is number of fluorine atoms in the molecule is larger than hydrogen atoms, and it may, for example, be CH₃OC₂F₅, CH₃OC₃F₇, C₅F₁₂H₂ (preferred structure is CF₃CFHCFHCF₂CF₂CF₃), C₆F₁₃H (preferred structure is CF₃CF₂CF₂CF₂CF₂CF₂H), or C₆F₁₂H₂ (preferred structure is CF₂HCF₂CF₂CF₂CF₂CF₂H).

The hydrochlorofluorocarbon is preferably such that the number of the hydrogen atoms is at most 3, and it may, for example, be CHClFCF₂CF₂Cl. As the chlorofluorocarbon, 1,1,2-trichlorotrifluoroethane may, for example, be mentioned.

A preferred solvent in the present invention is CHClFCF₂CF₂C₁ or CF₃CF₂CF₂CF₂CF₂CF₂H, and CClF₂CF₂CHClF is particularly preferred.

The amount of the polymerization medium to be used is preferably from 10 to 90%, more preferably from 30 to 70%, by a volume ratio to the volume of the polymerization tank. If the amount of the polymerization medium is small, the amount of the perfluorocarbon monomer which can be dissolved in the polymerization medium, will also be small, and the obtainable polymer will be small, such being industrially disadvantageous as the production efficiency becomes low. On the other hand, if the amount of the polymerization medium is too large, it tends to be difficult to uniformly stir the entirety. In the case of suspension polymerization or emulsion polymerization, water may be mentioned as the substantial polymerization medium.

In the present invention, it is preferred not to use a chain transfer agent substantially. Namely, if a chain transfer agent is used, hydrogen atoms are likely to be introduced to the terminal groups of the polymer, and the polymer is likely to be unstable.

The polymerization pressure is preferably from 0.05 to 10 MPa. If the polymerization pressure is too low, control of the reaction tends to be difficult, and if the polymerization pressure is too high, the equipment used for the production, would be more costly, which is undesirable. More preferably, a polymerization pressure of from 0.1 to 2.5 MPa is employed.

### Content of —SO₂F Groups

In the present invention, the content of —SO₂F groups in the perfluorocarbon polymer is evaluated by EW. EW is a mass per mol of —SO₂F groups of the obtainable perfluorocarbon polymer, and the lower the value of EW, the higher the content of —SO₂F groups.

According to the process of the present invention, it is possible to produce the present polymer having EW being from 600 to 900 g/mol.

### Molecular Weight

According to the process of the present invention, it is possible to produce the present polymer which has a molecular weight of at least 250,000 in spite of such low EW as mentioned above. Further, it is also possible to is produce the present polymer which has the molecular weight of at least 400,000.

Here, the molecular weight in the present invention is a weight average molecular weight measured by gel permeation chromatography (hereinafter referred to as GPC).

Control of the molecular weight can be carried out by the known method. In the case of solution polymerization, the molecular weight tends to decrease as the solvent concentration is made high, and the molecular weight tends to increase when the solvent concentration is made low. Further, the molecular weight may be adjusted by the addition of a chain transfer agent. Otherwise, it may be controlled by the amount of the initiator.

In the case of the present invention, the initiator is sequentially or continuously added, and when the concentration of the initiator present at the reaction site is made high, the polymerization rate becomes high, and at the same time, the molecular weight tends to decrease, and when the concentration of the initiator is made low, the polymerization rate becomes low, but the molecular weight tends to increase.

### Electrolyte Material

The present polymer can be made to be an electrolyte material by converting —SO₂F groups to —SO₃H groups or sulfonimide groups.

Further, prior to the conversion to —SO₃H groups or sulfonimide groups, fluorination treatment to contact the polymer with fluorine gas, may be carried out, whereby it will be possible to obtain an electrolyte material wherein unstable terminal groups of the polymer are less.

The conversion of —SO₂F groups to —SO₃H groups is carried out by hydrolysis followed by conversion to an acid form.

In the hydrolysis, —SO₂F groups in the perfluorocarbon polymer are converted to —SO₃Na groups or —SO₃K groups in a basic solution of e.g. NaOH or KOH using, as a solvent, water or a mixed liquid of water with an alcohol (such as methanol or ethanol) or a polar solvent (such as dimethylsulfoxide).

Then, in an aqueous solution of an acid such as hydrochloric acid, nitric acid or sulfonic acid, the —SO₃Na groups or —SO₃K groups are subjected to conversion to an acid form and converted to —SO₃H groups (sulfonic acid groups). The hydrolysis and the treatment for conversion to an acid form are usually carried out at a temperature of from 0 to 120° C.

As a method for the conversion to sulfonimide groups, a known method may be used. For example, a method disclosed in U.S. Pat. No. 5,463,005 or Inorg. Chem. 32 (23) p. 5007 (1993) may be mentioned. Namely, —SO₂F groups in the perfluorocarbon polymer are reacted with a sulfonamide or the like to convert them to base-derived salt type sulfonimide groups, followed by conversion to an acid form with an aqueous solution of hydrochloric acid, sulfonic acid or the like to form acid-form sulfonimide groups.

Otherwise, the present polymer may be contacted to ammonia to convert —SO₂F groups to sulfonamide groups and then contacted with a —SO₂F group containing compound such as trifluoromethanesulfonyl fluoride, heptafluoroethanesulfonyl fluoride, nonafluorobutanesulfonyl fluoride or undecafluorocyclohexanesulfonyl fluoride in the presence of a basic compound such as an alkali metal fluoride or an organic amine to carry out the conversion.

The electrolyte material obtainable from the present polymer (hereinafter referred to as the present electrolyte material) is useful as a polymer electrolyte membrane.

The polymer electrolyte membrane is obtainable by forming the present polymer into a film by melt extrusion or by heat pressing, and then converting —SO₂F groups to —SO₃H groups or sulfonimide groups.

Otherwise, it is also possible that with the present polymer in a powder state, —SO₂F groups are converted to —SO₃H groups or sulfonimide groups to obtain an electrolyte material, which is then dissolved in a solvent and formed into a film by a casting method. In such a case, the electrolyte membrane may be reinforced with e.g. a polytetrafluoroethylene porous material or polytetrafluoroethylene fiber (fibril).

The present electrolyte material is useful as a material constituting a membrane/electrode assembly for a polymer fuel cell.

The membrane/electrode assembly for a polymer fuel cell contains an anode and a cathode each having a catalyst layer containing a catalyst and an electrolyte material, and an electrolyte membrane interposed therebetween.

The present electrolyte material may be used for any of an electrolyte material constituting the above electrolyte membrane, an electrolyte material contained in the anode catalyst layer and an electrolyte material contained in the cathode catalyst layer, or it may be used for all of them.

The membrane/electrode assembly for a polymer fuel cell may be obtained in accordance with a usual method, for example, as follows. Firstly, a uniform dispersion containing a conductive carbon black powder having platinum catalyst particles or platinum alloy catalyst fine particles supported thereon, and an electrolyte material, is obtained, and a gas diffusion electrode is formed by any one of the following methods to obtain a membrane/electrode assembly.

A first method is a method wherein the above dispersion is applied to both surfaces of an electrolyte membrane and dried, and then two sheets of carbon cloth or carbon paper are closely bonded to both surfaces. A second method is a method wherein the above dispersion is applied on two sheets of carbon cloth or carbon paper and dried, and then the above electrolyte membrane is sandwiched so that the surfaces coated with the dispersion will closely be bonded to the electrolyte membrane. A third method is a method wherein the above dispersion is applied and dried on a substrate film separately prepared, to form a catalyst layer, then electrode layers are transferred to both surfaces of the electrolyte membrane, and further two sheets of carbon cloth or carbon paper are closely bonded to the two surfaces. Here, the carbon cloth or carbon paper is one having a function as a current collector and a function as a gas diffusion layer to diffuse gas more uniformly to the layer containing a catalyst.

On the obtained membrane/electrode assembly, a groove to constitute a pathway for fuel gas or oxidizing agent gas is formed, and the assembly is sandwiched between separators and assembled into a cell thereby to obtain a polymer fuel cell. In the polymer fuel cell, hydrogen gas is supplied to the anode side of the membrane/electrode assembly, and oxygen or air is supplied to the cathode side.

Now the present invention will be described in further detail with reference to Examples and Comparative Examples. However, it should be understood that the present invention is by no means thereby restricted.

### Example 1

Into a stainless steel reactor having an internal capacity of 10 mL and equipped with a stirrer, 7.238 g of CF₂═CFOCF₂CF(CF₃)O(CF₂)₂SO₂F (hereinafter referred to as PSVE) was charged in a N₂ atmosphere. Then, the temperature was raised to 33° C., and TFE was charged until the pressure became 0.497 MPaG (gauge pressure, the same applies hereinafter). Then 223 mg (as the amount of (HFPO)₃, the same applies hereinafter) of a solution having [CF₃CF₂CF₂OCF(CF₃)CF₂OCF(CF₃)COO]₂ (hereinafter referred to as (HFPO)₃) dissolved at a concentration of 0.13 mass % in CClF₂CF₂CHClF (hereinafter referred to as HCFC-225cb) was added to initiate the polymerization. During the reaction, the temperature was controlled to be constant. Further, the pressure decreases as the polymerization proceeds, and in order to maintain the pressure to be constant, TFE was continuously charged.

Further, after the initiation of the reaction, 112 mg of a solution having (HFPO)₃ dissolved at a concentration of 0.13 mass % in HCFC-225, was added nine times every 30 minutes. Namely, the total amount of (HFPO)₃ added was 1.6 mg, the molar ratio of this added total amount (mols) to the charged amount (mols) of PSVE was 1×10⁻⁴.

And, upon expiration of 5 hours from the initiation of the reaction, the internal temperature was cooled to room temperature, and unreacted TFE was reduced to terminate the reaction.

Here, as the half life of (HFPO)₃ at 33° C. is 30 minutes, the (HFPO)₃ concentration during the reaction is regarded as maintained within a range of from 1 to 0.5 time the concentration at the initiation of the polymerization.

The product obtained by the polymerization was diluted with HCFC-225cb in substantially the same volume as the polymerization solution and then flocculated by an addition of CCl₂FCH₃ (hereinafter referred to as HCFC-141b), followed by filtration.

Then, to the filtration residue, HCFC-225cb was added, followed by stirring and reflocculation with HCFC-141b, and the flocculated product was dried under reduced pressure at 80° C. for 16 hours. The amount of the obtained polymer was 523 mg.

The composition was analyzed by Raman spectro-analyzer, whereby structural units derived from PSVE in the polymer were 25.3 mol %, and EW obtained on the basis of this composition was 741. Further, the molecular weight Mw was measured by GPC and found to be 580,000.

### Example 2

Into a stainless steel reactor having an internal capacity of 10 mL and equipped with a stirrer, 7.238 g of PSVE and 95 mg of a solution having (HFPO)₃ dissolved at a concentration of 0.13 mass % in HCFC-225cb were charged in a N₂ atmosphere.

Then, the temperature was raised to 40° C., and TFE was charged until the pressure became 0.628 MPaG to initiate the polymerization. During the reaction, the temperature was controlled to be constant. Further, the pressure decreases as the polymerization proceeds, and in order to maintain the pressure to be constant, TFE was continuously charged.

Further, after the initiation of the reaction, 47.5 mg of a solution having (HFPO)₃ dissolved at a concentration of 0.13 mass % in HCFC-225cb was added 24 times every 12 minutes. Namely, the total amount of (HFPO)₃ added was 1.6 mg, and the molar ratio of the added total amount (mols) to the charged amount (mols) of PSVE was 1×10⁻⁴.

And, upon expiration of 5 hours from the initiation of the reaction, the internal temperature was cooled to room temperature, and unreacted TFE was released to terminate the reaction.

Here, the half life of (HFPO)₃ at 40° C. is 12 minutes, the (HFPO)₃ concentration during the reaction is regarded as maintained within a range of from 1 to 0.5 time the concentration at the initiation of the polymerization.

The product obtained by the polymerization was diluted with HCFC-225cb in substantially the same volume as the polymerization solution and then flocculated by an addition of HCFC-141b, followed by filtration.

Then, to the filtration residue, HCFC-225cb was added, followed by stirring, and reflocculation with HCFC-141b, and the flocculated product was dried under reduced pressure at 80° C. for 16 hours. The amount of the obtained polymer was 607 mg.

The composition was analyzed by a Raman spectro-analyzer, whereby structural units derived from PSVE in the polymer were 24.1 mol %, and EW obtained on the basis of this composition was 761. Further, the molecular weight Mw was measured by GPC and found to be 604,000.

### Example 3

Into a stainless steel reactor having an internal capacity of 10 mL and equipped with a stirrer, 0.615 g of PDD, 5.492 g of PSVE, and 69 mg of a solution having (HFPO)₃ dissolved at a concentration of 0.10 mass % in HCFC-225cb, were charged in a N₂ atmosphere.

Then, the temperature was raised to 40° C., and TFE was charged until the pressure became 0.162 MPaG to initiate the polymerization. During the reaction, the temperature was controlled to be constant. Further, the pressure decreases as the polymerization proceeds, and in order to maintain the pressure to be constant, TFE was continuously charged.

Further, after the initiation of the reaction, 0.0161 g (as PDD) of a solution having PDD dissolved at a concentration of 10.08 mass % in PSVE, was added ten times every 43.6 minutes. Namely, the charged amount of PDD was 0.78 g, and the charged amount of PSVE was 6.93 g.

Further, after the initiation of the reaction, 35 mg of a solution having (HFPO)₃ dissolved at a concentration of 0.10 mass % in HCFC-225cb was added 24 times every 19.2 minutes. Namely, the total amount of (HFPO)₃ added was 0.9 mg, and the molar ratio of this added total amount (mols) to the total charge (mols) of PSVE and PDD was 5×10⁻⁵.

And, upon expiration of 8 hours from the initiation of the reaction, 0.00018 g of a polymerization inhibitor of the following formula (8) was added, and unreacted TFE was released to terminate the reaction.

Here, the half life of (HFPO)₃ at 40° C. is 12 minutes, and the (HFPO)₃ concentration during the reaction is regarded as maintained within a range of from 0.25 to 1.0 time the concentration as the initiation of the polymerization.

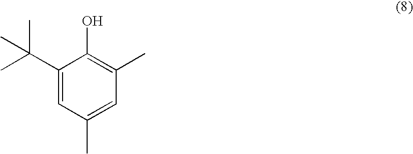

The product obtained by the polymerization was diluted with HCFC-225cb and then flocculated by an addition of hexane, followed by filtration.

Then, to the filtration residue, HCFC-225cb was added, followed by stirring and reflocculation with hexane, and the flocculated product was dried under reduced pressure at 80° C. for 16 hours. The amount of the obtained polymer was 342 mg.

The composition was analyzed by 19-FNMR, whereby structural units derived from PSVE in the polymer were 28.4 mol %, and structural units derived from PDD were 35.8 mol %. EW obtained on the basis of such a composition was 880. Further, the molecular weight Mw was measured by GPC and found to be 361,000.

### Comparative Example 1

Into a stainless steel reactor having an internal capacity of 10 mL and equipped with a stirrer, 7.238 g of PSVE, and 1.23 g of a solution having (HFPO)₃ dissolved at a concentration of 0.26 mass % in HCFC-225cb, were charged in a N₂ atmosphere.

Then, the temperature was raised to 21° C., and TFE was charged until the pressure became 0.421 MPaG to initiate the polymerization. During the reaction, the temperature was controlled to be constant. Further, the pressure decreases as the polymerization proceeds, and in order to maintain the pressure to be constant, TFE was continuously charged.

Namely, the total amount of (HFPO)₃ added was 3.21 mg, and the molar ratio of this added total amount (mols) to the charged amount (mols) of PSVE was 2×10⁻⁴.

And, upon expiration of 5 hours after the initiation of the reaction, the internal temperature was cooled to room temperature, and unreacted TFE was released to terminate the reaction.

The product obtained by the polymerization was diluted with HCFC-225cb in substantially the same volume as the polymerization solution and then flocculated by an addition of HCFC-141b, followed by filtration.

Then, to the filtration residue, HCFC-225cb was added, followed by stirring and reflocculation with HCFC-141b, and the flocculated product was dried under reduced pressure at 80° C. for 16 hours. The amount of the obtained polymer was 661 mg.

The composition was analyzed by a Raman spectro-analyzer, whereby structural units derived from PSVE in the polymer was 21.9 mol %, and EW obtained on the basis of this composition was 803. Further, the molecular weight Mw was measured by GPC and found to be 508,000.

### Comparative Example 2

Into a stainless steel reactor having an internal capacity of 10 mL and equipped with a stirrer, 0.526 g of PDD, 5.905 g of PSVE and 0.73 g of a solution having (HFPO)₃ dissolved at a concentration of 0.26 mass % in HCFC-225cb, were charged in a N₂ atmosphere.

Then, the temperature was raised to 21° C., and TFE was charged until the pressure became 0.107 MPaG to initiate the polymerization. During the reaction, the temperature was controlled to be constant. Further, the pressure decreases as the polymerization proceeds, and in order to maintain the pressure to be constant, TFE was continuously charged.

Further, 0.0137 g (as the amount of PDD) of a solution having PDD dissolved at a concentration of 8.18 mass % in PSVE, was added ten times every 43.6 minutes. Namely, the charged amount of PDD was 0.66 g, the charged amount of PSVE was 7.44 g, and the total amount of (HFPO)₃ added was 0.19 mg. The molar ratio of this added total amount (mols) to the total charged amount (mols) of PSVE and PDD was 1×10⁻⁴.

And, upon expiration of 8 hours from the initiation of the reaction, 0.00038 g of the polymerization inhibitor of the above formula (8) was added, and unreacted TFE was released to terminate the reaction.

The product obtained by the polymerization was diluted with HCFC-225cb and then flocculated by an addition of hexane, followed by filtration.

Then, to the filtration residue, HCFC-225cb was added, followed by stirring and reflocculation with hexane, and the flocculated product was dried under reduced pressure at 80° C. for 16 hours. The amount of the obtained polymer was 349 mg.

The composition was analyzed by 19-FNMR, whereby structural units derived from PSVE in the polymer were 27.6 mol %, structural units derived from PDD were 33.7 mol %. EW obtained on the basis of such a composition was 884. Further, the molecular weight Mw was measured by GPC and found to be 265,000.

The results in Examples and Comparative Examples are shown in Table 1.

TABLE 1

| | | Polymerization | | Molecular |
|---|---|---|---|---|
| | Monomers | temperature (° C.) | EW | weight (Mw) |
| Ex. 1 | PSVE/TFE | 33 | 741 | 580,000 |
| Ex. 2 | PSVE/TFE | 40 | 761 | 604,000 |
| Comp. | PSVE/TFE | 21 | 803 | 508,000 |
| Ex. 1 | | | | |
| Ex. 3 | PDD/PSVE/TFE | 40 | 880 | 361,000 |
| Comp. | PDD/PSVE/TFE | 21 | 884 | 265,000 |
| Ex. 2 | | | | |

In Examples 1 and 2, the polymerization time was the same as in Comparative Example 1. However, the molecular weights of the polymers obtained in Examples 1 and 2 were larger than the molecular weight of the polymer obtained in Comparative Example 1. Further, in Example 3, the polymerization time was the same as in Comparative Example 2. However, the molecular weight obtained in Example 3 was larger than the molecular weight of the polymer obtained in Comparative Example 2.

Namely, it has been found that by the polymerization process of the present invention, it is possible to obtain a polymer having a high content of functional groups and having a high molecular weight without lowering the yield obtainable in a predetermined polymerization time.

What is claimed is:

1. A process for producing a perfluorocarbon polymer comprising from 20 to 40 mol % of structural units obtainable from a liquid monomer (A) of the following formula (1) and structural units obtainable from tetrafluoroethylene and having a molecular weight of at least 250,000 and a mass per mol of —SO₂F groups being from 600 to 900 g/mol, by polymerizing a monomer mixture comprising the liquid monomer (A) and tetrafluoroethylene at a polymerization temperature of from 25 to 45° C. by sequentially or continuously adding an initiator of the following formula (2):
CF₂═CF(OCF₂CFX¹)ₖ—O₁—(CF₂)ₘ—(CF₂CFX²)ₙ—SO₂F (1)
wherein each of X¹ and X² which may be the same or different, is a fluorine atom or a trifluoromethyl group, k is an integer of from 0 to 3, l is 0 or 1, m is an integer of from 0 to 12, and n is an integer of from 0 to 3,
[CF₃CF₂CF₂O(CF(CF₃)CF₂O)ₚCF(CF₃)COO]₂ (2)
wherein p is an integer of from 0 to 8.

2. The process for producing a perfluorocarbon polymer according to claim 1, wherein the monomer mixture further contains a liquid monomer of the following formula (3) and/or a liquid monomer of the following formula (4)

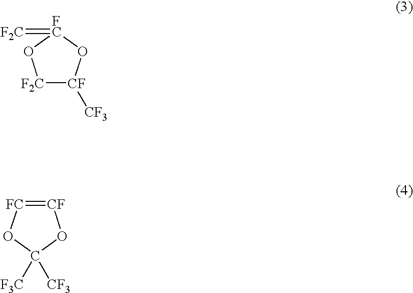

3. The process for producing a perfluorocarbon polymer according to claim 1, wherein the concentration of the initiator (X) during the polymerization is maintained within a range of from 0.25 to 2 times the concentration of the initiator (X) at the beginning of the polymerization.

4. The process for producing a perfluorocarbon polymer according to claim 1, wherein the concentration of the initiator (X) during the polymerization is maintained within a range of from 0.5 to 1.5 times the concentration of the initiator (X) at the beginning of the polymerization.

5. The process for producing a perfluorocarbon polymer according to claim 1, wherein the molar ratio of the total amount of the initiator (X) to be added, to all liquid monomers, is adjusted to be from 1×10⁻⁵ to 3×10⁻³.

6. The process for producing a perfluorocarbon polymer according to claim 1, wherein the molar ratio of the total amount of the initiator (X) to be added, to all liquid monomers, is adjusted to be from 5×10⁻⁵ to 1×10⁻³.

7. The process for producing a perfluorocarbon polymer according to claim 1, wherein the polymerization is carried out at a polymerization temperature of from 30 to 45° C.

8. The process for producing a perfluorocarbon polymer according to claim 1, wherein the molecular weight is at least 400,000.
